(19) United States
(12) Patent Application Publication
(10) Pub. No.: US 2010/0147916 A1
(43) Pub. Date: Jun. 17, 2010

(54) Snowmobile Accessories

(75) Inventors: Chris Roberts, Clarkston, WA (US); Kathy Roberts, Clarkston, WA (US)

Correspondence Address: WELLS ST. JOHN P.S., 601 W. FIRST AVENUE, SUITE 1300, SPOKANE, WA, 99201, US

(73) Assignee: POWDER KEG, LLC, Clarkston, WA (US)

(21) Appl. No.: 12/636,550

(22) Filed: Dec. 11, 2009

Related U.S. Application Data
(63) Continuation-in-part of application No. 12/333,141, filed on Dec. 11, 2008.

(51) Int. Cl. B60R 9/06

(52) U.S. Cl. 224/408

(57) ABSTRACT

Removable storage compartments are provided that can include a compartment housing formed to extend along sidewalls from a base portion and define an opening, a lid configured to couple with the housing and at least partially close the opening, with the lid not extending beyond the outermost portion of the sidewalls. Compartments can also have a least one mounting bracket recessed within at least one of the sidewalls. Methods of mounting a storage compartment to a snowmobile are provided that can include mounting a portion of a hasp to a portion of a snowmobile, providing a storage compartment having another portion of the hasp mounted thereto, and coupling the portions of the hasp to mount the compartment to the snowmobile, the coupled compartment having the hasp recessed below the compartment and within a perimeter define by the compartment. Ornamental designs for snowmobile accessories as shown in FIGS. 6-12.

### RELATED APPLICATION

This application is a continuation-in-part of U.S. non-provisional patent application Ser. No. 12/333,141 filed Dec. 11, 2008 and entitled “Snowmobile Accessories”, the entirety of which is incorporated by reference herein.

### TECHNICAL FIELD

The present disclosure relates to personal transport accessories and in particular embodiments to snowmobile accessories.

### BACKGROUND

Personal transport vehicles such as snowmobiles typically are designed to transport a single person and little attention is given to storage space for personal or even safety items. Snowmobiles, for example are typically designed to provide comfort to the rider and at the same time maximize transport efficiency. As part of maximizing efficiency, storage of personal and/or safety items, for example, are typically not accounted for and riders are left to transport items using backpacks. Backpacks can be unsafe as they may cause the rider to be unbalanced when riding and/or provide an item that can become snagged on low hanging branches, for example.

### SUMMARY OF DISCLOSURE

Removable storage compartments configured to mount rear of a snowmobile seat are provided. The compartments can include a compartment housing formed to extend along sidewalls from a base portion and define an opening, the sidewalls defining the outermost portion of the compartment in one cross section. The compartments can also include a lid configured to couple with the housing and at least partially close the opening, wherein the lid does not extend beyond the outermost portion of the sidewalls when coupled with the housing in one cross section.

Compartments can also be configured to include a compartment housing formed to extend vertically along sidewalls from a base portion and define an opening above the base portion, the sidewalls defining the outermost portion of the compartment in one cross section. The compartment can also have a lid configured to compliment the opening, and a least one mounting bracket recessed within at least one of the sidewalls.

Methods of mounting a storage compartment to a snowmobile are provided that can include mounting a portion of a hasp to a portion of a snowmobile, providing a storage compartment having another portion of the hasp mounted thereto, and coupling the portions of the hasp to mount the compartment to the snowmobile, the coupled compartment having the hasp recessed below the compartment and within a perimeter defined by the compartment.

Sets of snowmobile accessories are provided that can include a first compartment for dry storage, and a second compartment for liquid storage, the compartments configured to removably-fixedly couple one another with at least one of the compartments configured to removably-fixedly engage a portion of the snowmobile.

Ornamental designs for snowmobile accessories as shown in FIGS. 5-11.

### DRAWINGS

Embodiments of the disclosure are described below with reference to the following accompanying drawings.

FIG. 1. is an isometric view of an accessory according to an embodiment of the disclosure.

FIGS. 2A, 2B, and 2C are lateral as well as cross sections and detail views of an accessory according to embodiments of the disclosure.

FIGS. 3A, 3B, 3C, and 3D are multiple views of an accessory according to embodiments of the disclosure.

FIGS. 4A, 4B, and 4C are multiple views of an accessory according to embodiments of the disclosure.

FIG. 5 is a perspective view of a snowmobile accessory according to an embodiment.

FIG. 6 is a left side view of the snowmobile accessory of FIG. 7.

FIG. 7 is a right side view of the snowmobile accessory of FIG. 7.

FIG. 8 is a rear view of the snowmobile accessory of FIG. 7.

FIG. 9 is a front view of the snowmobile accessory of FIG. 7.

FIG. 10 is a top view of the snowmobile accessory of FIG. 7.

FIG. 11 is a bottom view of the snowmobile accessory of FIG. 7.

FIG. 12 is a snowmobile having a snowmobile accessory thereon according to an embodiment of the present disclosure.

FIG. 13 is a snowmobile having a snowmobile accessory thereon according to an embodiment of the present disclosure.

FIG. 14 is a snowmobile having snowmobile accessories thereon according to an embodiment of the present disclosure.

FIG. 15 is a snowmobile having snowmobile accessories thereon according to an embodiment of the present disclosure.

FIG. 16 is a snowmobile having snowmobile accessories thereon according to an embodiment of the present disclosure.

FIG. 17 is a snowmobile and a snowmobile accessory according to an embodiment of the present disclosure.

FIG. 18 is a snowmobile and snowmobile accessories according to an embodiment of the present disclosure.

FIG. 19 is a cross section of a snowmobile accessory according to an embodiment of the disclosure.

### DESCRIPTION

This disclosure is submitted in furtherance of the constitutional purposes of the U.S. Patent Laws “to promote the progress of science and useful arts” (Article 1, Section 8).

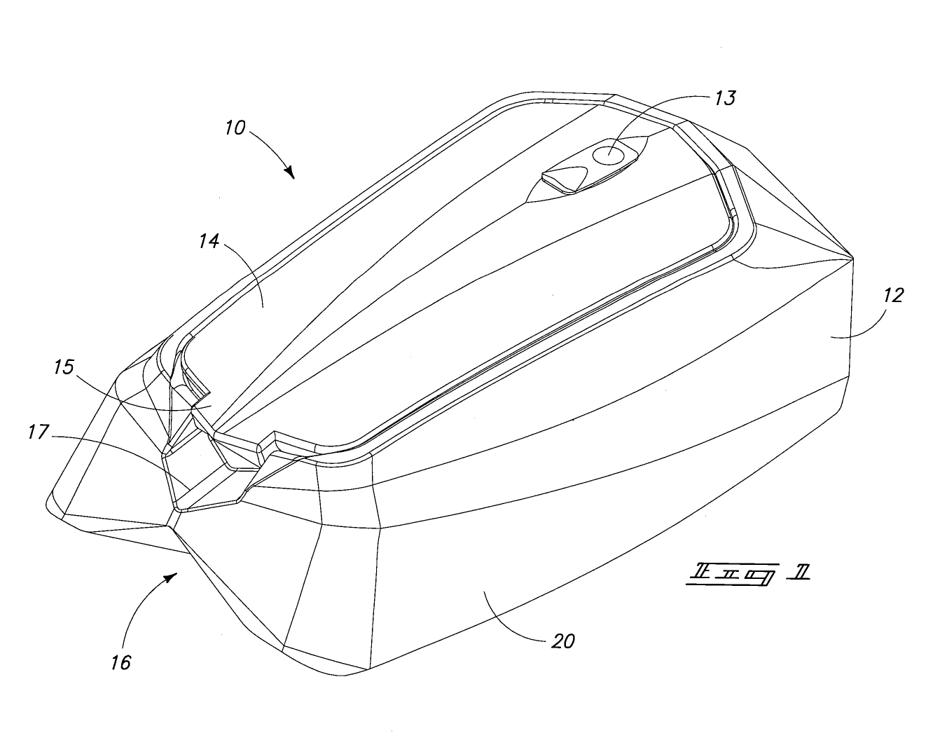

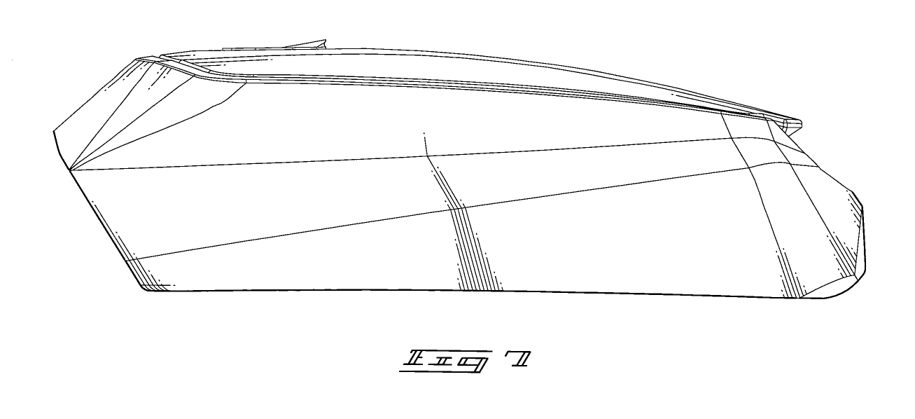

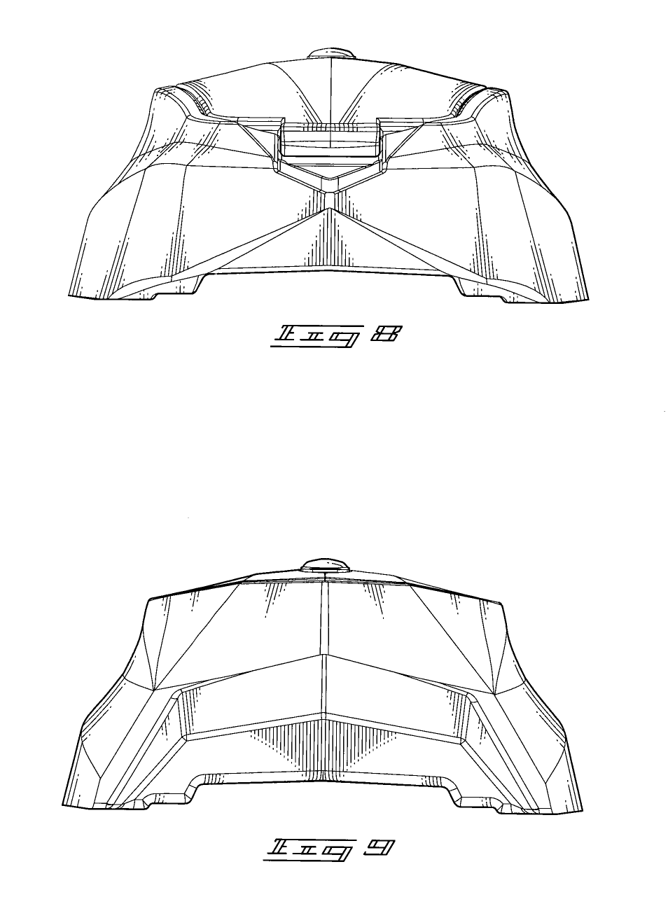

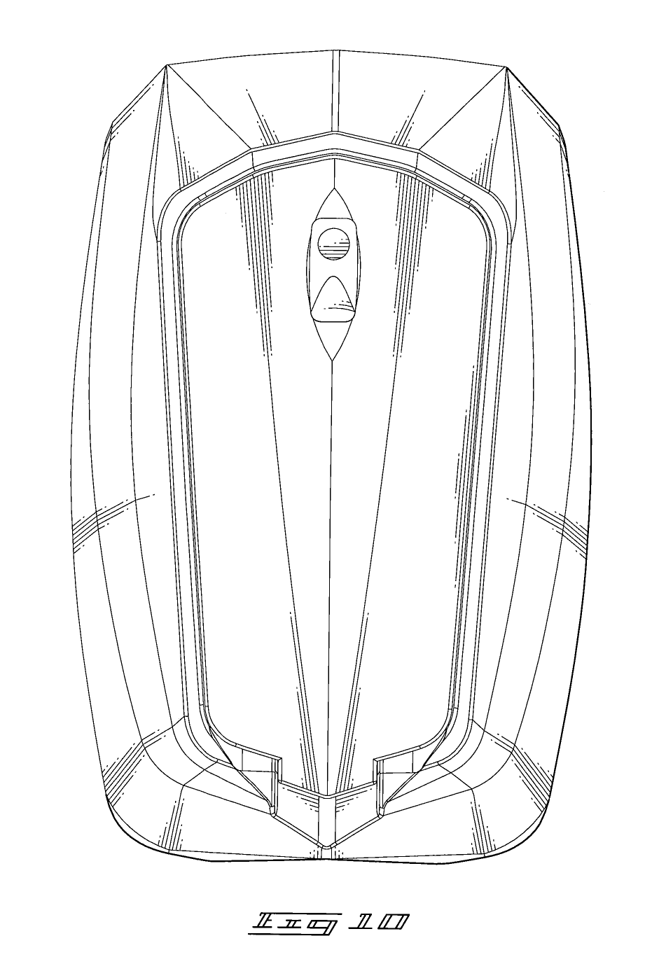

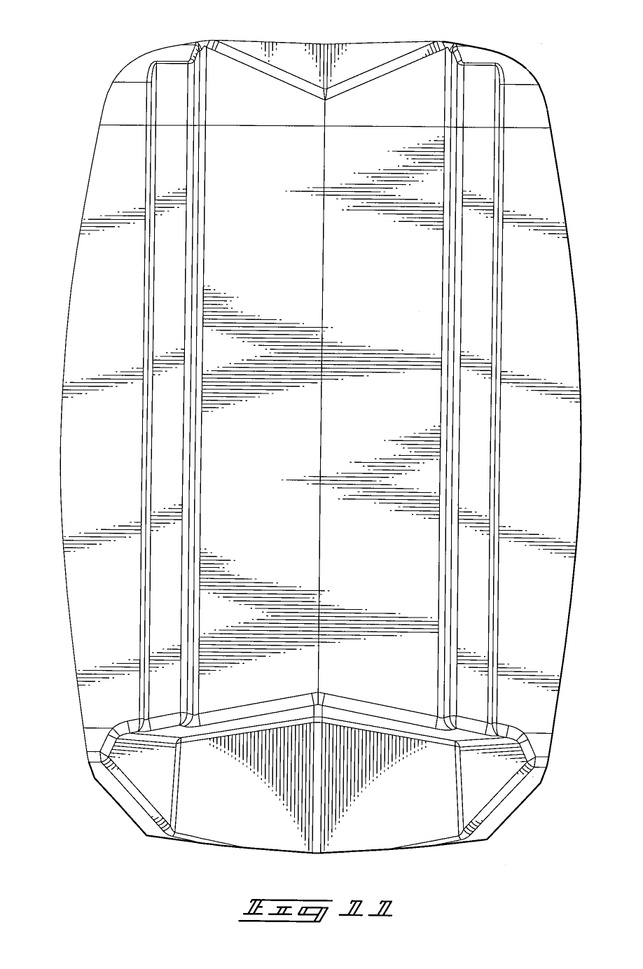

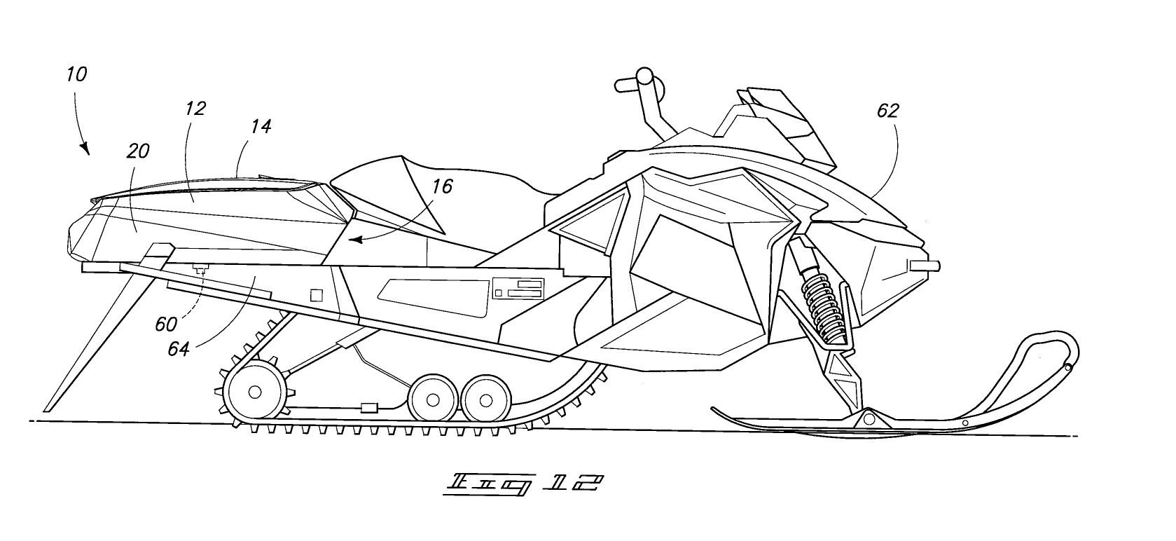

Snowmobile accessories of the present disclosure include removable snowmobile storage compartments and methods of using same. These accessories are described with reference to FIGS. 1-19. Referring to FIG. 1, an isometric view of removable compartment 10 is shown that includes housing 12 and lid 14. According to example implementations, the storage compartment can be configured to compliment and/or engage with the rear portion of a snowmobile seat. Typically, snowmobiles include an extension extending over the snowmobile tracks to protect the rider in the event the rider falls from the snowmobile. According to example implementations, the accessory can be mounted above that extension.

Housing 12 can include a recess 16 to engage a rear portion of the snowmobile seat, such as the pedestal supporting the seat. In accordance with example implementations, recess 16 can facilitate the mounting of compartment 10 to the rear of a snowmobile seat. Housing 12 can also define a recess 17. Recess 17 can be configured to receive a portion of lid 14 when lid 14 is in the open position as lid 14 can be pivotally attached at portion 15 to housing 12. Lid 14 can include latch 13 which can be configured to maintain lid 14 in the closed position. The housing and/or lid can comprise a rigid material such as a plastic, fiberglass, polycarbonate, carbon fiber, and/or metal materials, for example. Lid 14 may also comprise a flexible material, even a fabric type material, for example.

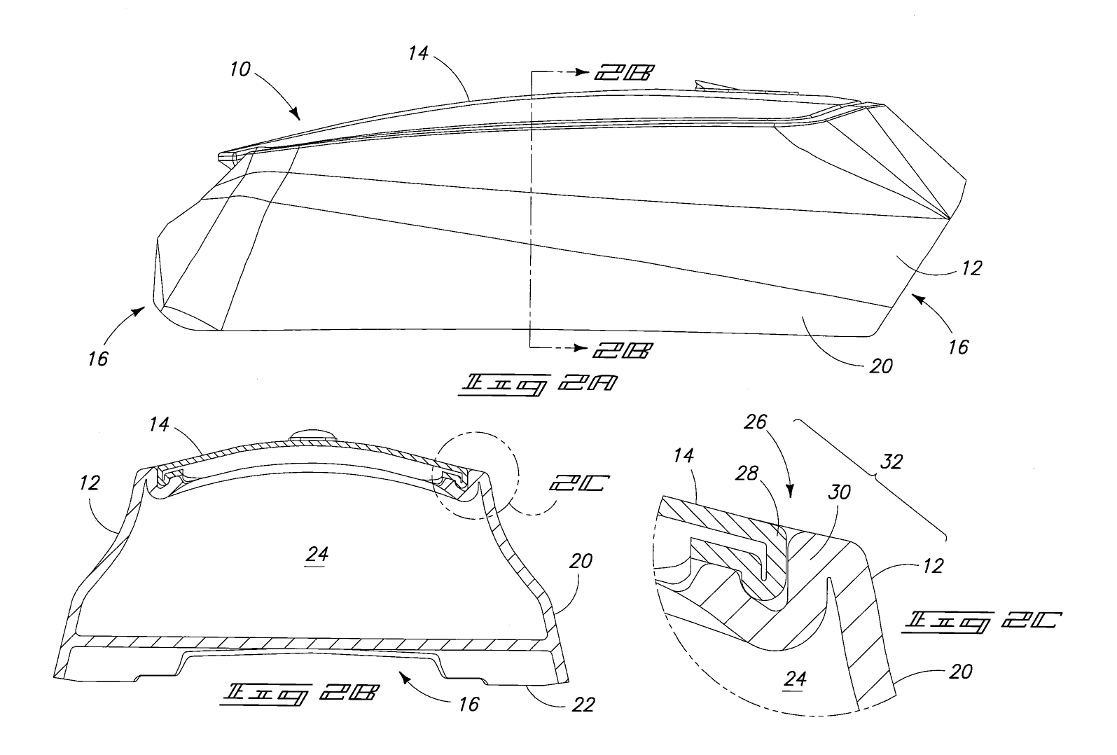

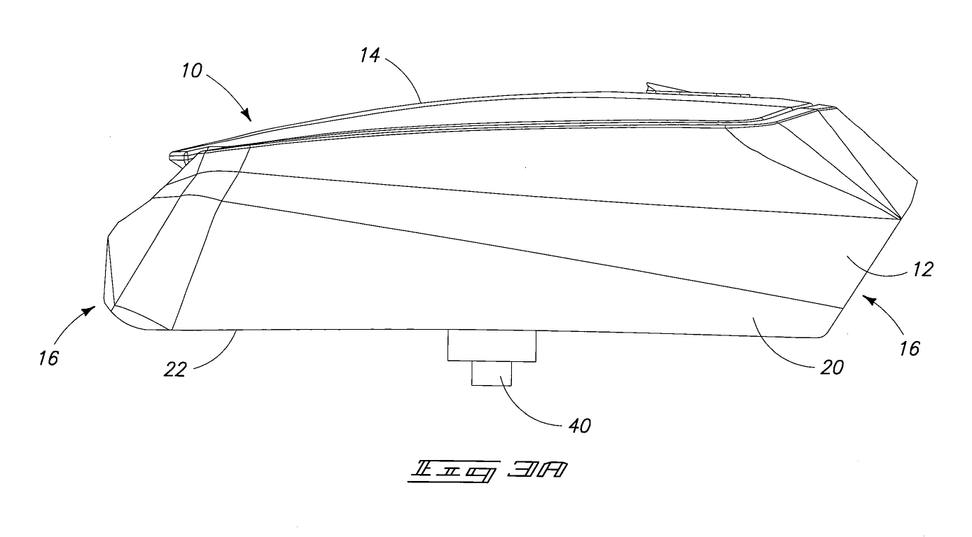

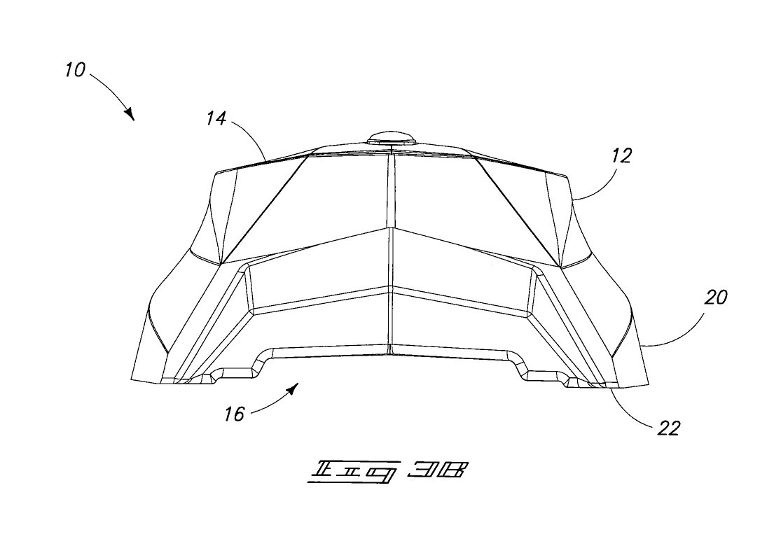

Referring to FIGS. 2A through 2C, compartment 10 can include compartment housing 12 that extends along sidewalls 20 from a base portion 22, with the sidewalls defining the outermost portion of the compartment in one cross section. Lid 14 can be configured to couple with the housing and at least partially, if not fully, close the opening defined by sidewalls 20 which extend from base 22. As can be seen in FIG. 2B, according to an example implementation, lid 14 can be configured to be received within sidewalls 20 of compartment 10 in one cross section. With reference to FIG. 2C, lid 14 and compartment 10, particularly sidewall 20 of compartment 10, can include complimentary portions as shown in portions 26 configured to provide a rigid coupling when the lid is coupled to the compartment. According to example implementations, the outer edge 28 of lid 14 can be configured to compliment inner edge 30 of sidewalls 20 to form an arcuate joint 32.

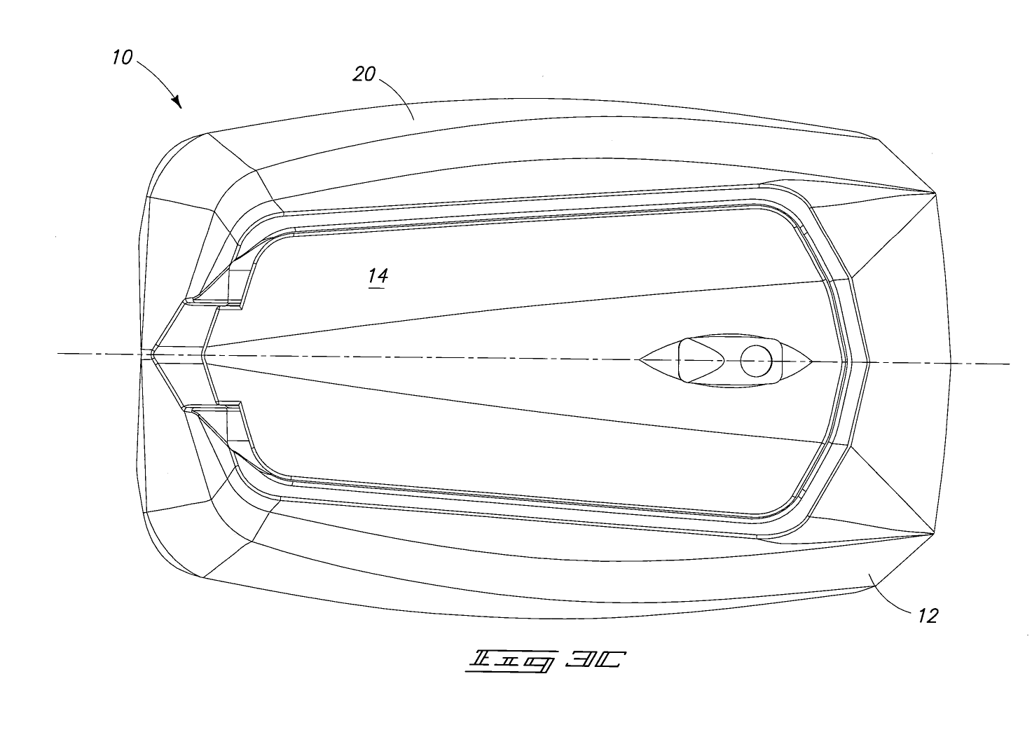

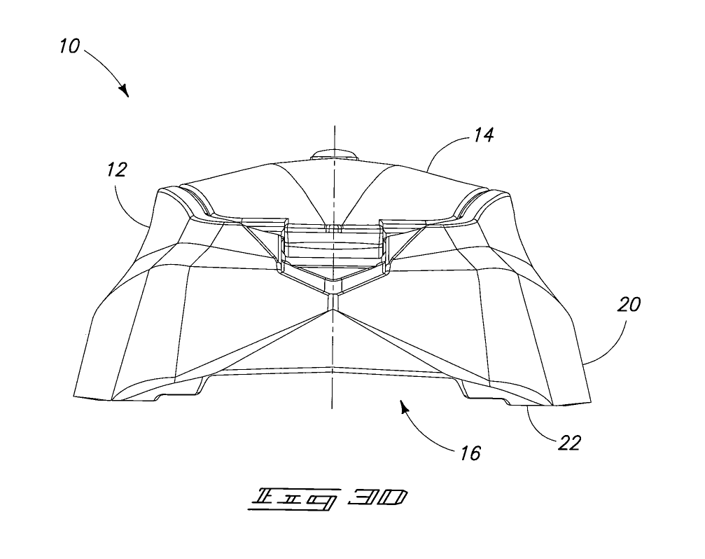

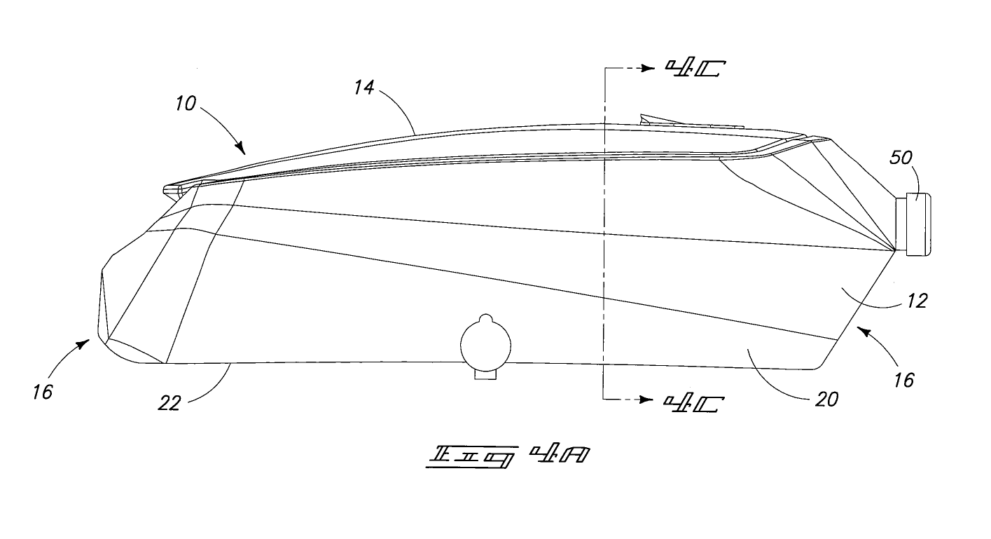

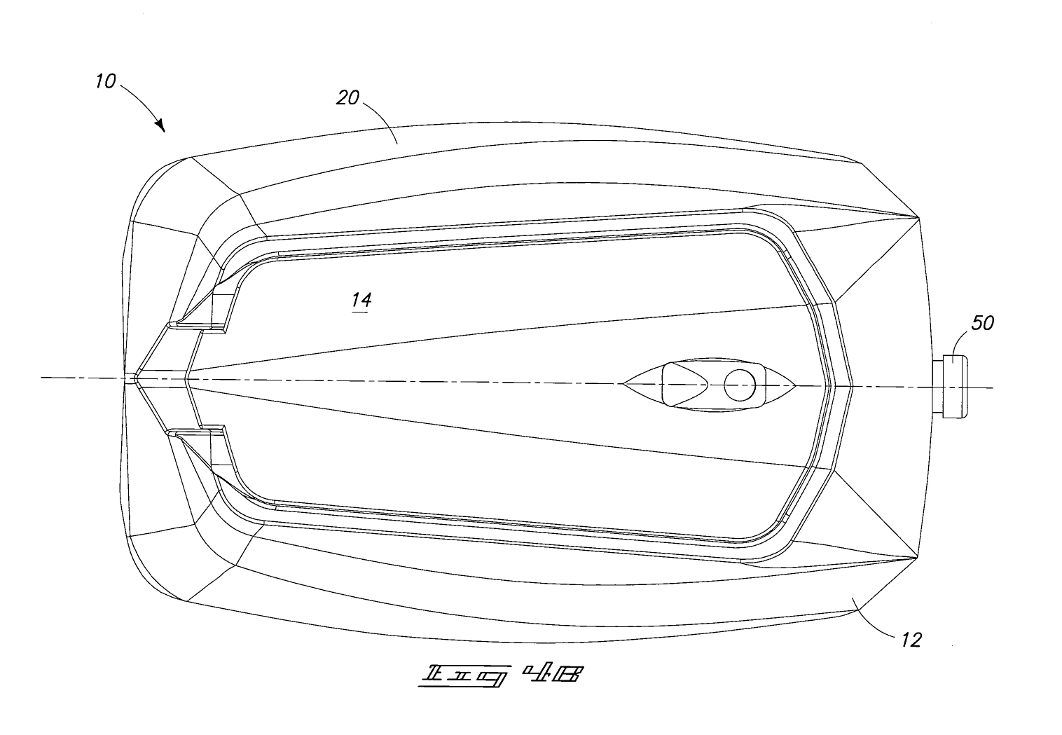

Referring to FIGS. 3A through 3D, compartment 10 can be configured to include at least one mounting bracket 40 recessed within at least one of the sidewalls 20. This mounting bracket can be a hasp, for example, and as such, the compartment can be configured to be removably-affixedly coupled to the snowmobile. By being removably-affixedly coupled, the compartment can be affixed to the snowmobile and then removed from the snowmobile via use of the hasp, for example. According to implementations, bracket 40 can be a quick release mechanism, allowing the snowmobile rider to release the compartment from the snowmobile while wearing weather protective gear such as snowmobile gloves. According to example implementations, the hasp can be a draw hasp, for example.

Compartment size can depend, for example, on the snowmobile to which they are to be attached. According to example implementations, the size of the compartment may not extend beyond a perimeter defined rearward of the seat of the snowmobile. As an example, implemented according to an embodiment, an affixed compartment can allow a snowmobile rider to easily exit and mount the snowmobile, for example, without being impeded by edges of the compartment. According to example implementations, housing 12 and lid 14 can define an interior of the compartment such as that shown in FIG. 2B.

According to example implementations, the interior of the compartment can be undivided. According to other implementations, the interior of the compartment can further define regions configured to receive additional accessories and/or tools, for example, flashlights and/or safety equipment such as flares. According to other implementations, a tail light may be directly mounted to the compartment and the compartment may be configured with an electrical adapter configured to couple to the snowmobile and provide power to the tail light. According to other implementations, the compartment may be rigidly affixed or permanently affixed to the snowmobile utilizing bolts, for example. According to other implementations, the compartment and snowmobile may include complimentary Velcro equipped pads or alignment pins and openings to be used to prevent side-to-side or end play movement between the compartment and the tunnel or extension over the rear of the snowmobile.

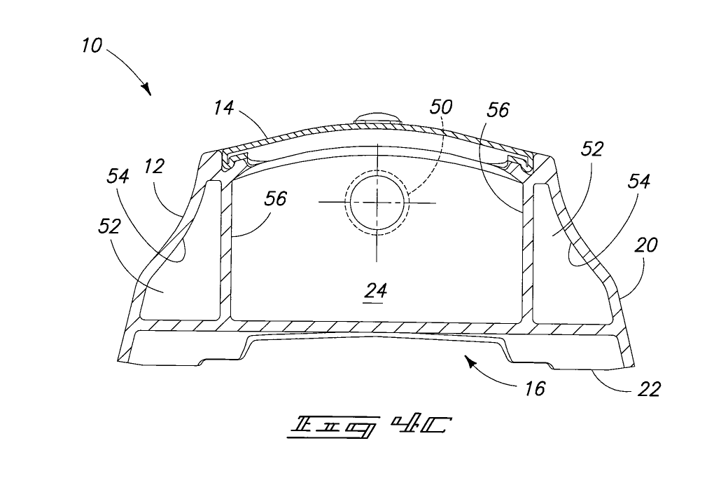

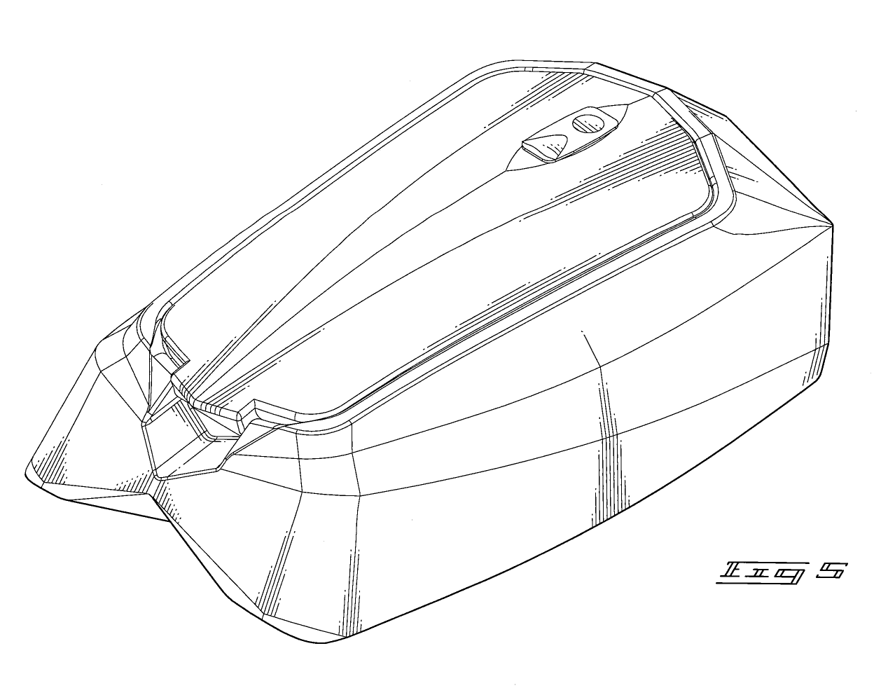

Referring to FIGS. 4A through 4C, according to other example implementations, compartment 10 can be configured to include a void for storing liquids for use during snowmobiling activities. Such liquids can include water, for example, and/or fuel if required. Sidewalls 20 of compartment 10 can define a void 52 between outer sidewalls 54 and inner sidewalls 56. This void can be continuous throughout the perimeter of the compartment and extend to a cap assembly 50. Such cap assembly can be a screw cap and/or snap cap design depending on the application. According to example implementations, this can be considered a double walled storage compartment. According to example implementations, the cap assembly 50 can also be configured as a spout in fluid communication with void 52. In accordance with this implementation, liquid may be maintained in the perimeter of the compartment while dry goods and/or tools are in the interior of the compartment.

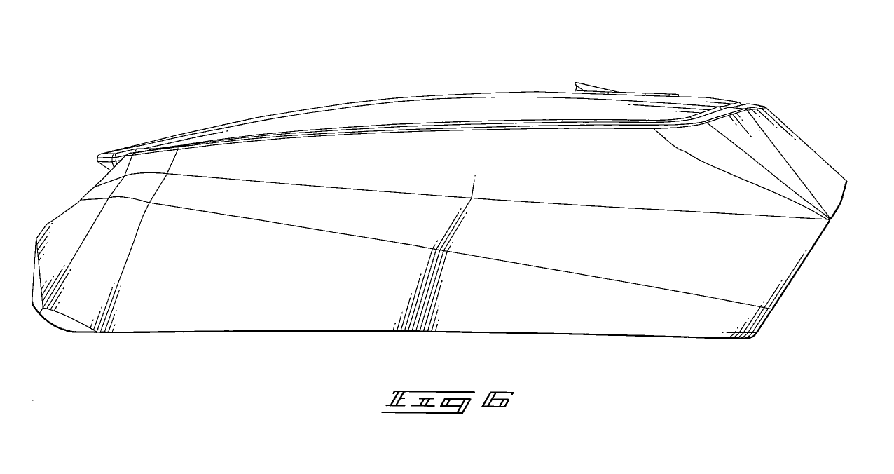

FIGS. 5-11 depict an ornamental design of a snowmobile accessory.

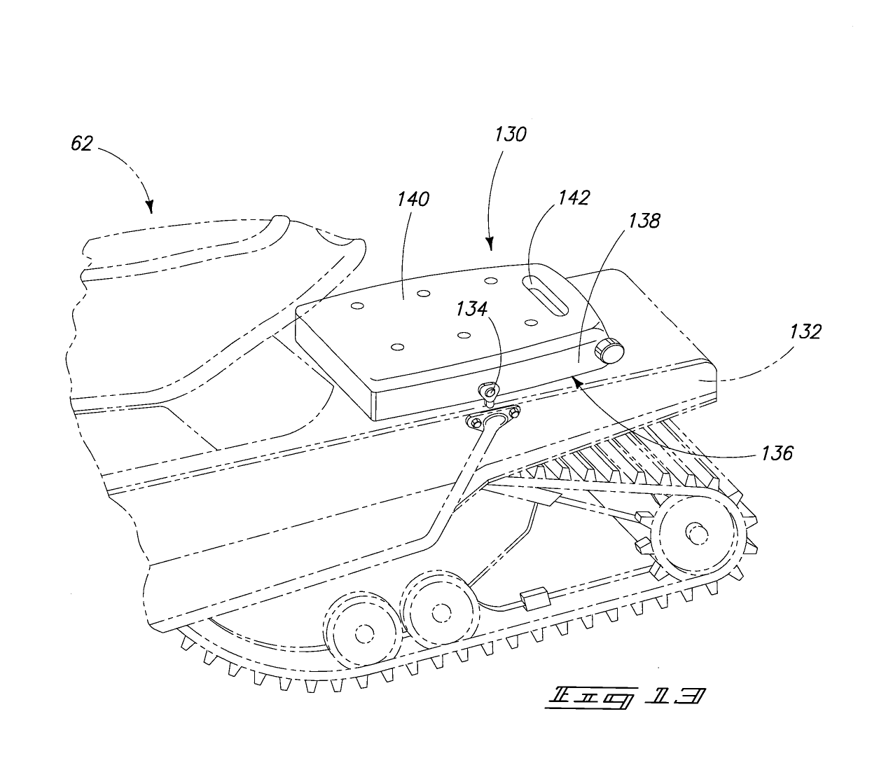

Referring to FIG. 12, according to example implementations, snowmobile 62 can have compartment 10 mounted thereto. According to particular embodiments, a method for mounting a storage compartment to a snowmobile can include mounting a portion of a hasp 60 to a portion of a snowmobile 62. According to an example implementation, the portion that hasp 60 is mounted to is referred to as the tunnel portion 64, or the portion extending over the rear portion of the snowmobile tracks or treads. The method can further include providing a storage compartment 10 having another portion of hasp 60 mounted thereto and the method can further provide coupling the portions of hasp 60 to mount compartment 10 to snowmobile 62. According to example implementations, the coupled compartment 10 can have hasp 60 received below the compartment and within a perimeter defined by the compartment.

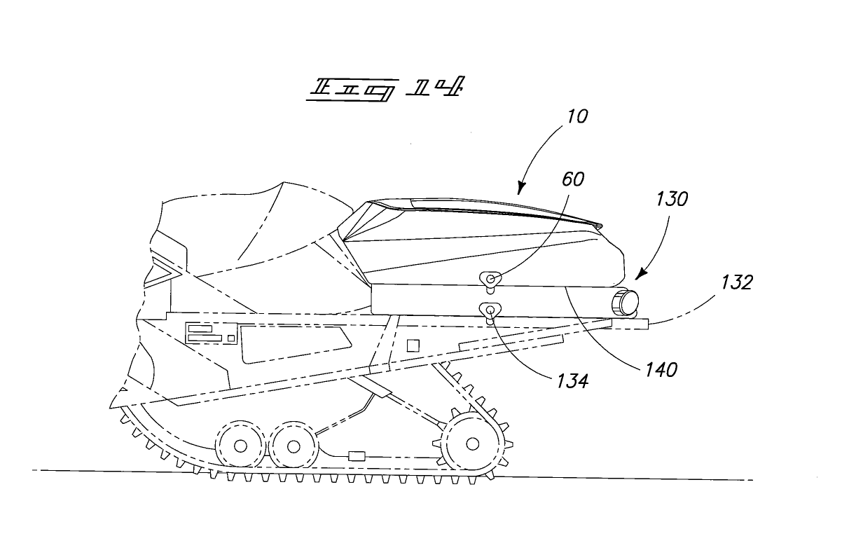

Referring to FIG. 13 and in accordance with another embodiment of the present disclosure a compartment 130 is shown above tunnel 132 of snowmobile 62. Compartment 130 can be configured to removably-fixedly engage a portion of the snowmobile. The portion of the snowmobile engaging the compartment can be tunnel 132 of the snowmobile. For example, at latch 134 compartment 130 can be removably-fixedly coupled to tunnel 132.

Compartment 130 can include a base 136 extending along sidewalls 138 to a platform 140. In accordance with example implementations, base 136, sidewalls 138 and platform 140 can define at least a portion of the volume within compartment 130. More particularly, sidewalls 138 can define a substantially rectangular perimeter of compartment 130. Base 136 of compartment 130 can be configured to engage an upper portion of tunnel 132, for example. In accordance with example implementations, compartment 130 can define an opening 142. Opening 142 can be configured to receive a hand and act as a handle when transporting compartment 130 apart from snowmobile 62.

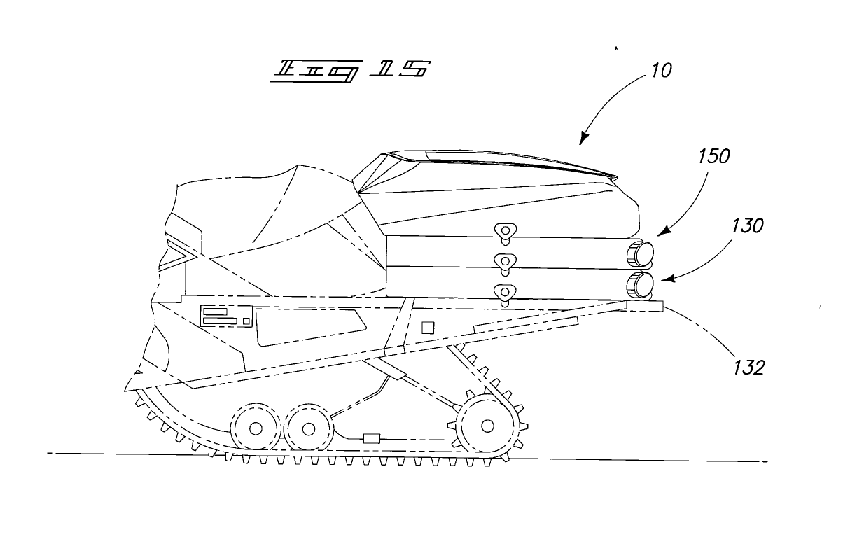

With reference to FIG. 14, and in accordance with example implementations, a set of snowmobile accessories can be provided with the set including a first compartment for dry storage such as compartment 10, and a second compartment for liquid storage, such as compartment 130. The compartments can be configured to removably-fixedly couple to one another. For example, latch 60 can be configured to couple to compartment 130. At least one of the compartments such as compartment 130 can be configured to removably-fixedly engage a portion of the snowmobile such as tunnel 132. In accordance with example implementations, platform 140 can be configured to receive a lower portion of another compartment, such as the base of compartment 10.

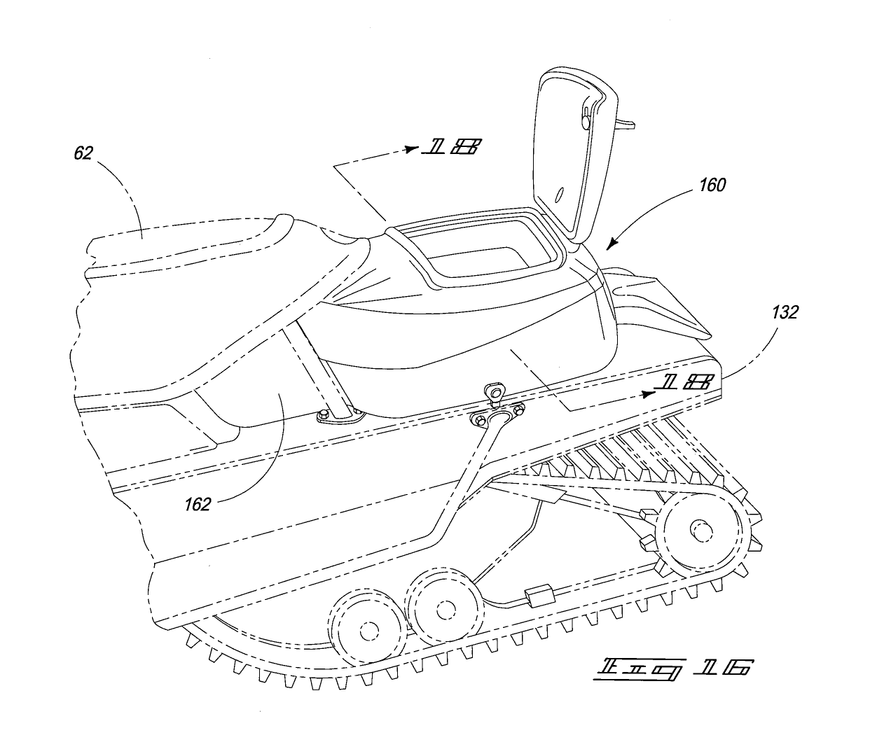

With reference to FIG. 15, and in accordance with yet another embodiment of the present disclosure, a set of accessories can include a third compartment 150 for liquid storage. Compartment 150 can be identical to compartment 130, for example. According to example implementations, compartment 150 may have a base that compliments the platform of compartment 130, and/or may have a platform that compliments a base of compartment 10. Compartments 130 and 150 may be configured to stack upon one another, and further compartment 10 may be configured to reside at the top of this stack. The compartments may be configured to be removably-fixedly coupled to one another, and this coupling may be accomplished via latch hasp.

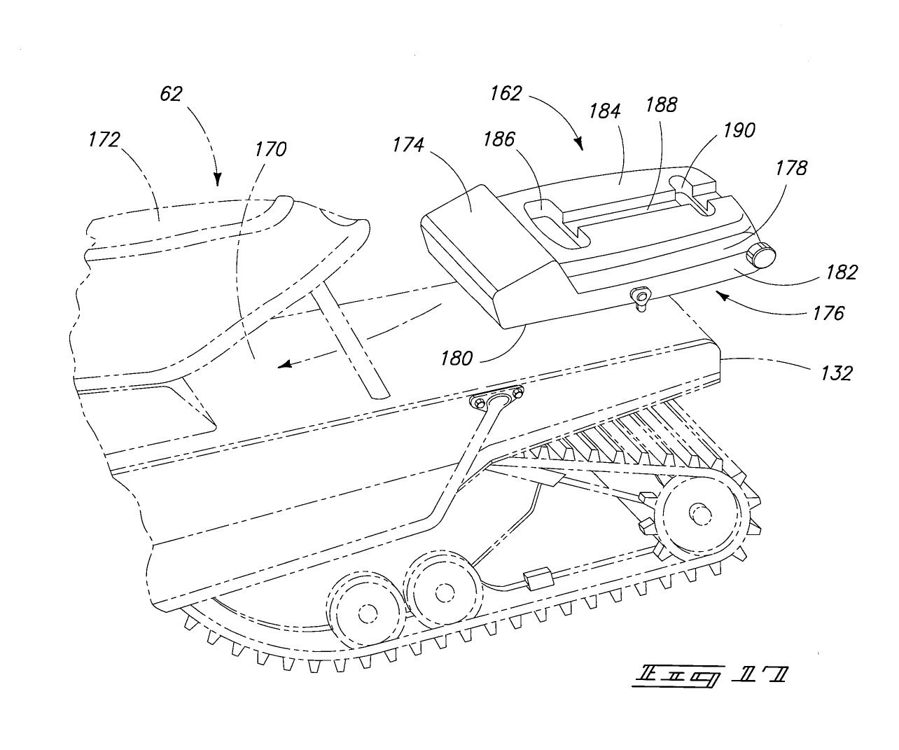

Referring to FIGS. 16-19, and in accordance with other embodiments of the present disclosure, sets of snowmobile accessories can include a first compartment for dry storage, such as compartment 160, and a second compartment for liquid storage, such as compartment 162. The compartments can be configured to removably-fixedly couple to one another with at least one of the compartments configured to removably-fixedly engage a portion of the snowmobile.

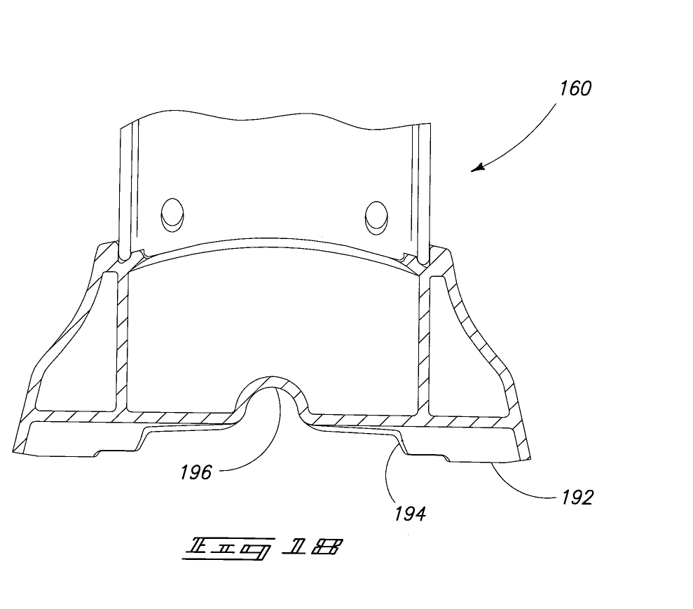

Referring to FIG. 17, snowmobile 62 can define a space 170 between seat 172 and tunnel 132 of the snowmobile. In accordance with example implementations, a first portion 174 of compartment 162 can be configured to engage and/or compliment space 170. Portion 174 may be tapered and/or wedged shaped and can be placed proximate the rider of snowmobile 62. Portion 174 can be configured to compliment a perimeter of space 170.

Compartment 162 can further include a second portion such as portion 176. Portion 176 can be configured to engage compartment 160. For example, portion 176 can include tapered edges 178 configured to be received by a tapered recess of compartment 160. Further compartment 160 can be configured to receive portion 174 as well. In accordance with example implementations, portion 174 can extend along a first base such as base 180 to portion 176. Portion 176 can include sidewalls 182 extending from the first base to platform 184. Platform 184 can be configured to receive compartment 160. Within platform 184 can be recesses 186 and 188. These recesses can be configured to receive all or portions of a tool, such as shovel. For example, recess 186 can be configured to receive a handle of a shovel and recess 188 can be configured to receive a member of the shovel with the member extending from the handle. Further, opening 190 can be defined by compartment 162. Opening 190 can be configured to receive a hand and utilized to carry compartment 162 when it is separate and apart from snowmobile 62.

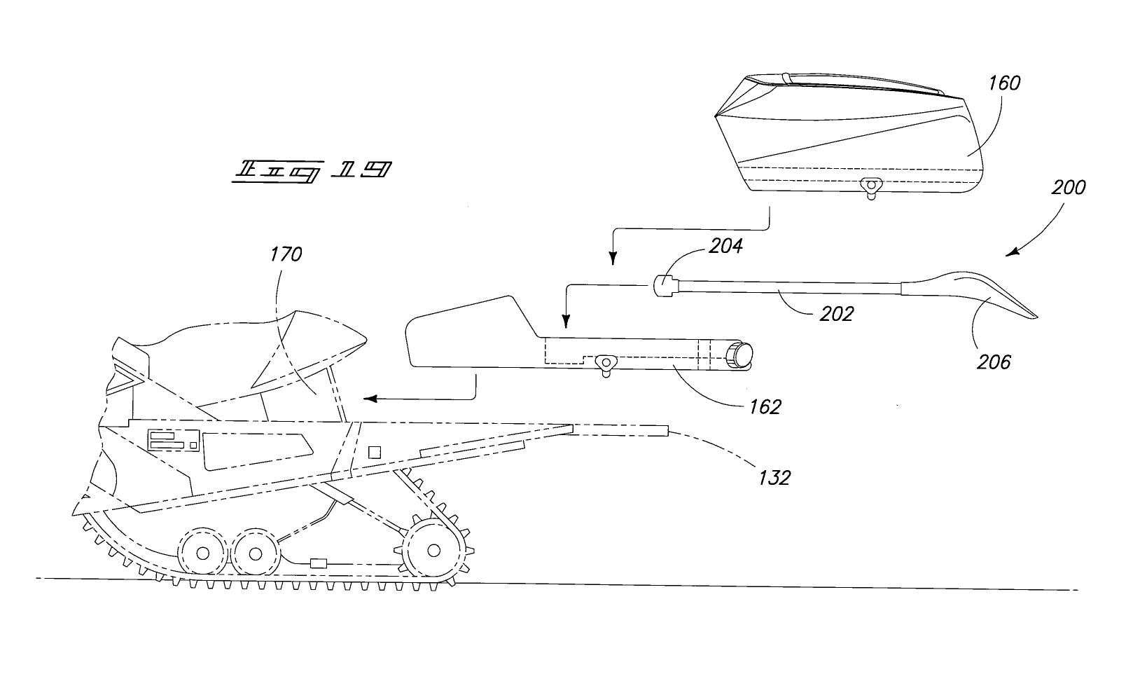

Referring to FIG. 18, compartment 160 can include a base 192 and a portion of base 192 can be configured to engage platform 184. As an example configuration, compartment 160 can include a tapered portion 194 configured to fixedly engage compartment 162, at for example edge 178 of portion 176. In accordance with example embodiments, compartment 160 can be configured to envelop portion 176 of compartment 162 when engaged therewith. Further, compartment 160 can define a recess 196 configured to receive a portion of the tool and/or removably-fixedly engage a portion of a tool, such as the member of the tool that extends from the handle of the tool.

Referring to FIG. 19, and in accordance with an embodiment of the disclosure, a set of accessories can include compartment 162, tool 200, and/or compartment 160. Tool 200 can include an elongated member 202 having a first end coupled to handle 204 and a second end coupled to scoop 206. Compartment 162 can be engaged to a snowmobile within space 170 and/or fixedly coupled to tunnel 32 via a latch. Tool handle 204 of tool 200 can be placed in a recess such as recess 186 and member 202 can be placed in a recess such as recess 188. Compartment 160 can engage compartment 162, and receive member 202 within a recess such as recess 196. In accordance with embodiments of the disclosure, tool 200 can be configured to removably-fixedly engage one or both of compartments 160 and/or 162.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A set of snowmobile accessories comprising:
a first compartment for dry storage; and
a second compartment for liquid storage, the compartments configured to removably-fixedly couple one another with at least one of the compartments configured to removably-fixedly engage a portion of the snowmobile.

2. The set of claim 1 wherein the snowmobile defines a space between the seat of the snowmobile and the tunnel of the snowmobile, a first portion of the second compartment being configured to engage the space.

3. The set of claim 2 wherein the first portion of the second compartment compliments a perimeter of the space defined between the seat of the snowmobile and the tunnel of the snowmobile.

4. The set of claim 2 wherein the second compartment further defines a second portion being configured to engage the first compartment.

5. The set of claim 4 wherein the first portion extends along a first base to the second portion, the second portion comprising sidewalls extending from the first base to a platform configured to receive the first compartment.

6. The set of claim 5 wherein the first compartment comprises a second base, the second base being configured to engage the platform of the second compartment.

7. The set of claim 1 further comprising at least one tool configured to removably-fixedly engage one or both of the first and second compartments.

8. The set of claim 7 wherein the second compartment defines a recess configured to removably-fixedly engage a portion of the tool.

9. The set of claim 8 wherein the tool comprises a handle, the recess configured to engage the handle of the tool.

10. The set of claim 9 wherein the tool comprises an elongated member having a first end coupled to the handle, the first compartment having a base defining a recess therein to receive at least a portion of the member.

11. The set of claim 1 wherein the portion of the snowmobile is the tunnel of the snowmobile, and the second compartment is configured to removably-fixedly engage the tunnel of the snowmobile.

12. The set of claim 1 wherein the second compartment comprises a base extending along sidewalls to a platform, the sidewalls defining a substantially rectangular perimeter of the compartment.

13. The set of claim 12 wherein the base of the compartment is configured to engage an upper portion of a tunnel of the snowmobile.

14. The set of claim 12 wherein the platform is configured to receive a lower portion of another compartment.

15. The set of claim 14 wherein the other compartment is a third compartment for liquid storage.

16. The set of claim 15 wherein the third compartment is identical to the second compartment.

17. The set of claim 16 wherein the set further comprises another second compartment, the two second compartments being configured to stack upon one another and the first compartment being configured to rest upon the top second compartment in the stack.

18. The set of claim 17 wherein the compartments are configured to be removably-fixedly coupled to one another.

19. The set of claim 18 wherein the compartments are removably-fixedly coupled to one another via a latch hasp.

20. The set of claim 14 wherein the other compartment is the first compartment.
